(19) United States
(12) Patent Application Publication
(10) Pub. No.: US 2009/0139976 A1
(43) Pub. Date: Jun. 4, 2009

(54) IMPINGEMENT QUARTZ CONVEYOR OVEN

(76) Inventor: Robert Lee, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/327,679

(22) Filed: Dec. 3, 2008

Related U.S. Application Data
(60) Provisional application No. 60/991,997, filed on Dec. 3, 2007.

(51) Int. Cl. A21B 1/00

(52) U.S. Cl. 219/400

(57) ABSTRACT

An impingement oven includes a housing with a conveyor 114 extending through the housing to convey food items through a cooking chamber for cooking by convection and infrared heating elements located above and below the conveyor. Electrical components are separated from the heating elements and cooled with ambient air.

### CROSS-REFERENCE TO RELATED APPLICATIONS

This application is related to U.S. Provisional Patent Application No. 60/991,997 filed Dec. 3, 2007 from which priority is claimed, and is hereby incorporated by reference.

### STATEMENT REGARDING FEDERALLY SPONSORED RESEARCH

Not Applicable.

### BACKGROUND OF THE INVENTION

The invention relates to the field of impingement ovens.

Impingement ovens can provide fast and even cooking of food items. Often used in conjunction with conveyors, impingement ovens heat food items with convection, or more specifically with forced impingement convection, by directing jets of heated air onto food items, such as pizza and sandwiches, as they pass through a cooking chamber of the oven on the conveyor. A blower, and convection heating elements, heat and circulate air to the cooking chamber from a separate circulation duct. Impingement ovens may also include radiant or infrared heating elements above the conveyor to enhance toasting of the food items.

While impingement ovens have proven to be an effective and valuable cooking device, they have also proven to be incredibly inefficient. The location and position of various components in current designs contribute to a number of undesirable attributes, including, shorter life of components, thermal inefficiencies, and poor process control. For example, some current designs impinge only the bottom of food items with heated air rather than the top of the food items, which results in poor heating performance for many food items. Also, convection heating elements are typically located within the circulation duct in close proximity to the blower, blower motor, and other electrical components. In this location, the heating elements transmit considerable amounts of radiant energy to the blower motor and electronics, thereby, raising the temperature and significantly shortening the life of these components. In addition, temperature sensors located within the circulation duct are negatively affected by the radiant energy, resulting in poor process control of the oven. Moreover, the radiant energy is wasted by locating the heating elements within the circulation duct where the radiant energy can not reach the food items. The location of the heating elements also obstructs the air flow through the circulation duct. Also, maintenance of the heating elements is made more difficult by their position in the circulation duct, due to poor access for inspection, cleaning, and replacement. These inefficiencies result in an impingement oven that requires more power and time for operation and maintenance and has a shorter operation lifespan.

Therefore, a more efficient impingement oven with longer life and better process control is needed.

### DESCRIPTION OF THE DRAWINGS

In the accompanying drawings which form part of the specification:

FIG. 1 is an orthogonal projection of an oven assembly;

FIG. 2 is a cross-section view of the oven assembly along line A-A of FIG. 1;

FIG. 3 is a cross-section view of the oven assembly along line A-A of FIG. 1 illustrating the infrared energy distribution;

FIG. 4 is a cross-section view of the oven assembly along line B-B of FIG. 1 illustrating the air flow within a plenum and a cooking chamber;

FIG. 5 is a cross-section view of the oven assembly along line B-B of FIG. 1 illustrating the air flow within the cooling duct;

FIG. 6 is a top view of the oven assembly of FIG. 1 illustrating the air flow within the cooling duct and the plenum.

FIG. 7 is a side view of the oven assembly of FIG. 1;

FIG. 8 is a front view of the oven assembly of FIG. 1;

FIG. 9 is a perspective cross-section view along line A-A of FIG. 1;

FIG. 10 is a partially exploded view of the oven assembly of FIG. 1;

FIG. 11 is a cross-section view of an alternate oven assembly along line illustrating the air flow within a plenum and a cooking chamber

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

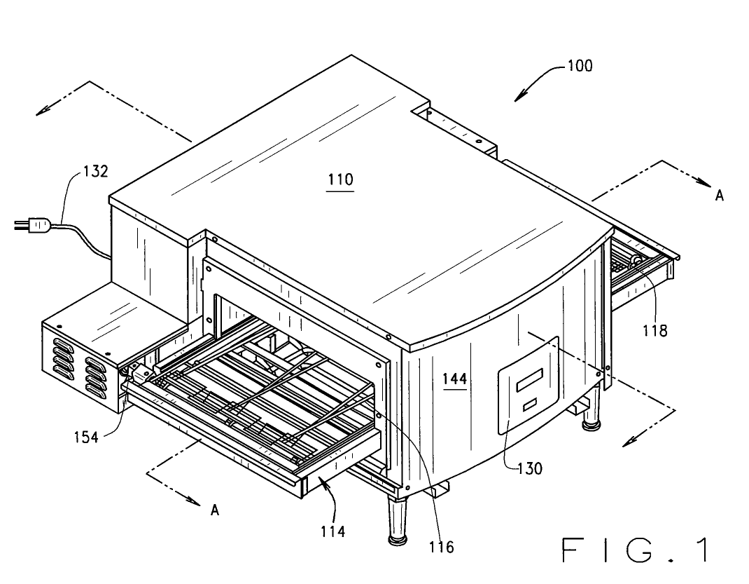

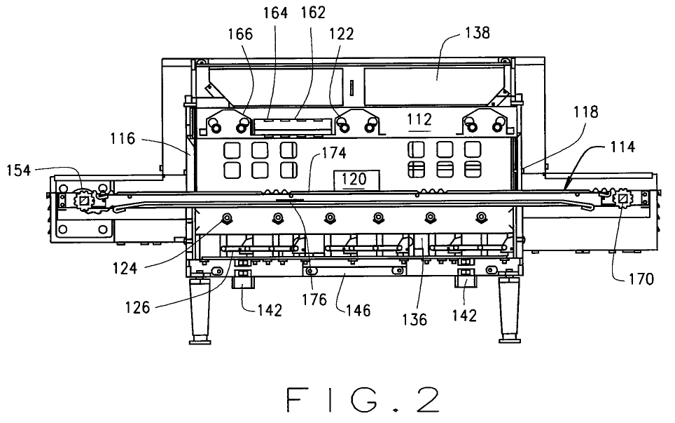

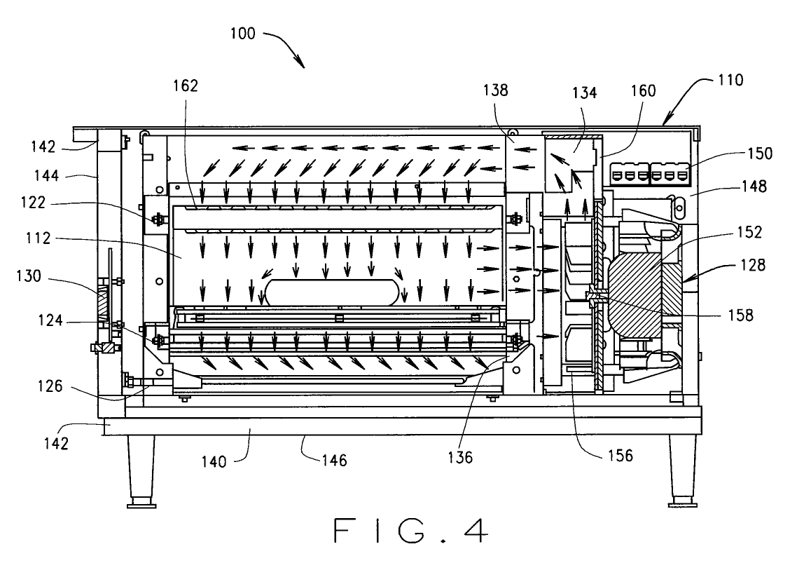

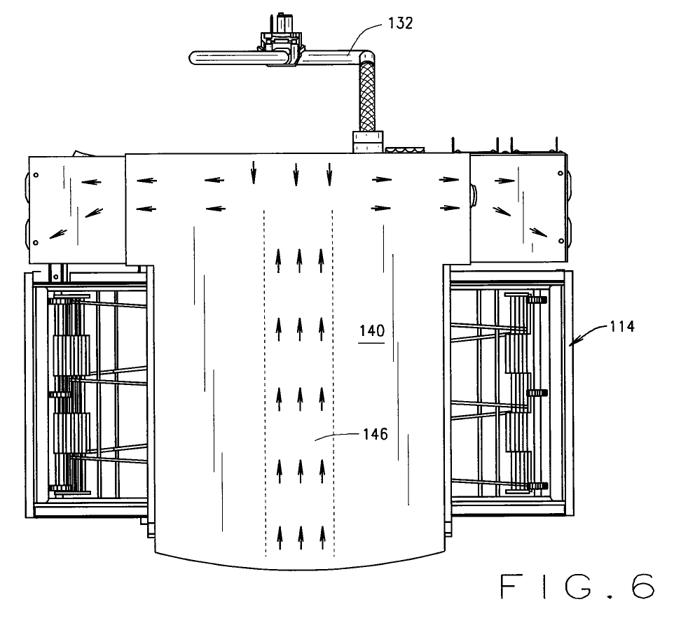

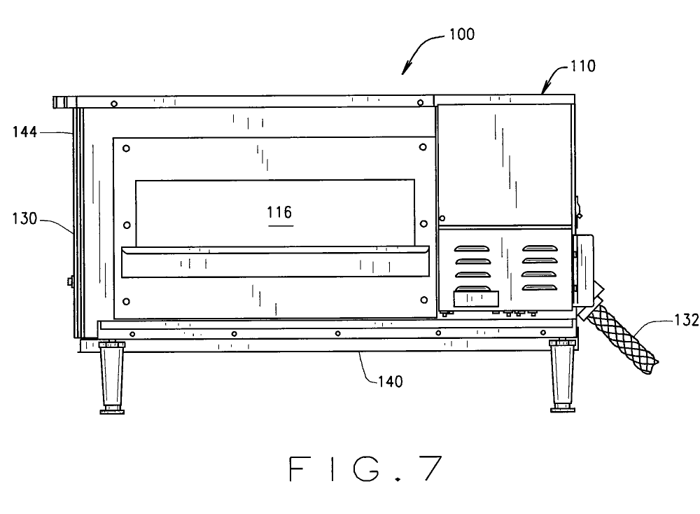

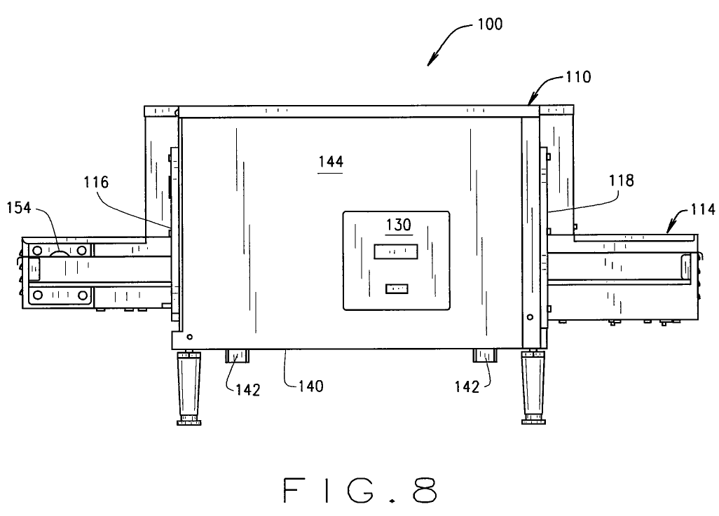

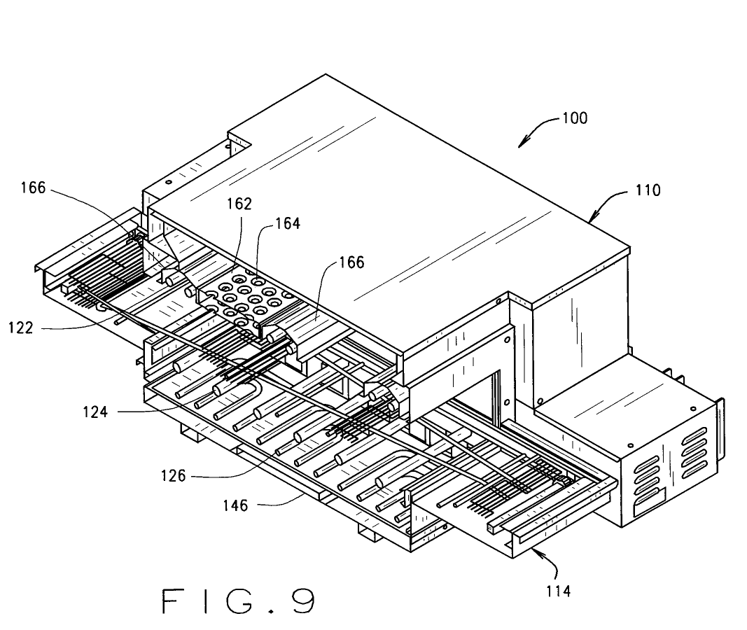

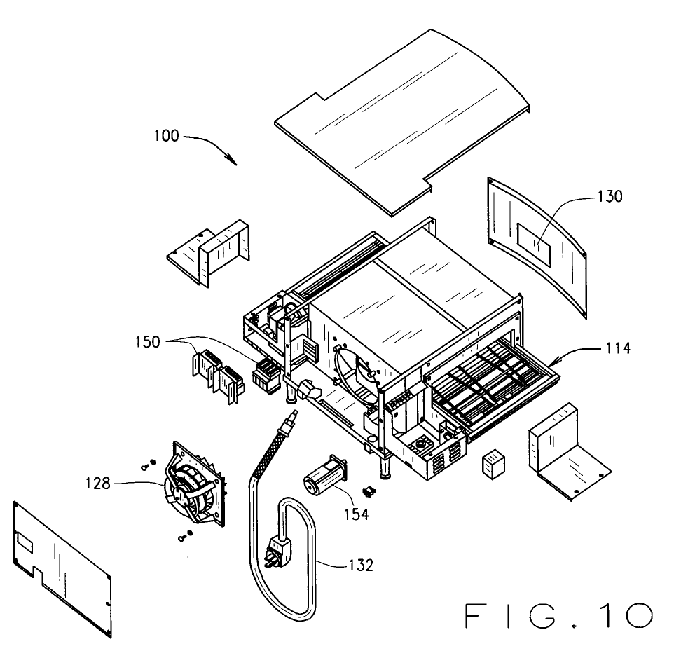

As shown in FIGS. 1-10, an embodiment of the present invention, generally referred to as an impingement oven 100, includes a housing 110 defining a cooking chamber 112, and a conveyor 114 extending through the housing 110 from a entrance opening 116 to an exit opening 118. The conveyor 114 conveys food items 120 through the cooking chamber 112 for cooking by convection and infrared heating elements 122, 124, and 126 located above and below the conveyor 114 (FIG. 2). A blower assembly 128 located within the housing 110, circulates air heated by the heating elements 122, 124, and 126 within the cooking chamber 112 to enhance cooking of the food items 120 by convection, or more specifically by forced impingement convection (FIG. 4). A control panel 130 positioned on the exterior of the housing 110 operatively connects to the heating elements 122, 124, and 126, to the conveyor 114, to the blower assembly 128, and to a power supply 132 (FIG. 1). An operator engages the control panel 130 to select the desired operating settings of the oven 100.

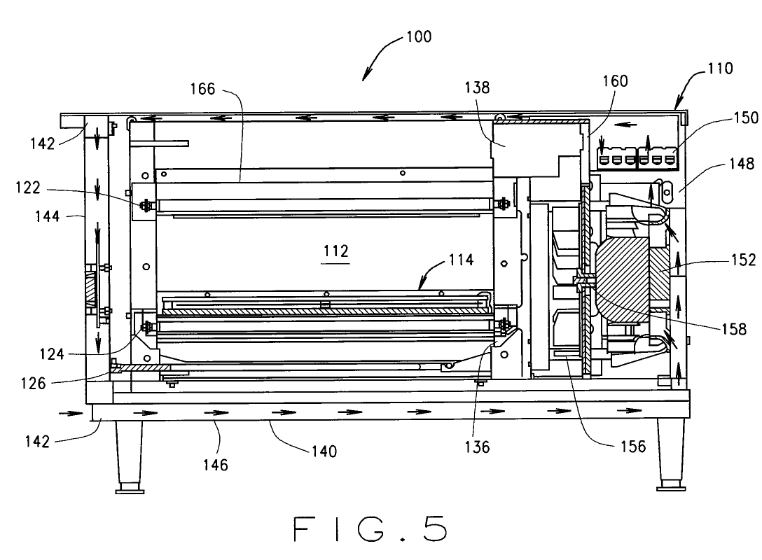

The housing 110 also defines a circulation duct 134 in communication with the cooking chamber 112 through inlet 136 at the lower portion of the cooking chamber 112 and an outlet 138 at the upper portion of the cooking chamber 112 (FIG. 4). Together, the circulation duct 134 and the cooking chamber 112 form a continuous loop (or generally circular path) for the air to travel around. A cooling channel 140 draws in ambient air through inlets 142 at the front 144 of the housing 110, and communicates the air through the front control area 145 along the bottom 146 of the housing 110 to a controls chamber 148 (FIGS. 5, 6, and 10). The ambient air cools the various equipment housed within the controls chamber 148, such as electronics 150, a blower motor 152, and a conveyor motor 154. The ambient air also flows from the controls chamber 148 through an upper cooling channel 147 to the front control area 145 and out through various air gaps, such as inlets 142 in the front 144 of the housing 110 (FIG. 5).

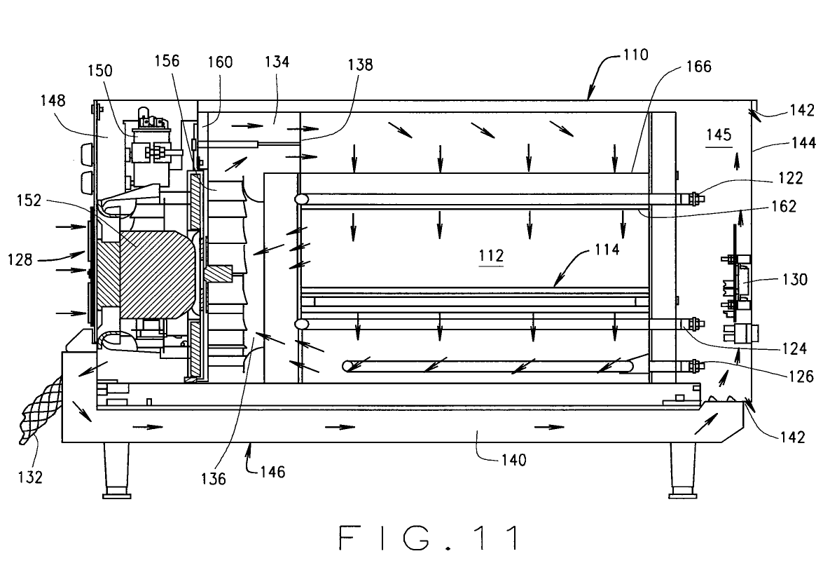

In an alternative embodiment (FIG. 11), the ambient air can be drawn into the controls chamber 148 through inlets 149 at the rear of the housing 110 and adjacent to the blower motor 128. From the control chamber 148, the ambient air flows through the cooling channel 140 and the upper cooling channel 147 to the front control area 145 and exit the inlets 142, which act as outlets in this alternate embodiment.

The blower assembly 128 includes a fan 156 positioned within the circulation duct 134. (FIG. 4). The fan 156 connects to the blower motor 152 positioned within the controls chamber 148 to insulate the blower motor 152 from the heated air in the circulation duct 134. A second fan 157 positioned within the controls chamber 148 also connects to the blower motor 152. A motor shaft 158 extends from the blower motor 152 through an inner wall 160 to engage with the fan 156 and second fan 157. The blower motor 152 operatively connects to the control panel 130. In operation, the blower motor 152 rotates the fan 156, which draws air from the cooking chamber 112 through the inlet 136 and forces the air through the outlet 138 to impingement panels 162. The impingement panels 162 are mounted above the conveyor 114. A plurality of apertures 164 evenly spaced about the impingement panels 162 direct air flow downwardly at increased speed towards the conveyor 114 to impinge the food items 120 (FIGS. 2, 4, and 9). The acceleration of the air flow is caused by the constriction of air as it passes through the apertures 164, which produces a pressure rise on the upwind side of the apertures 164 and a pressure drop of the downwind side of the apertures 164 as the air diverges. This phenomenon is oftentimes referred to as the Venturi effect.

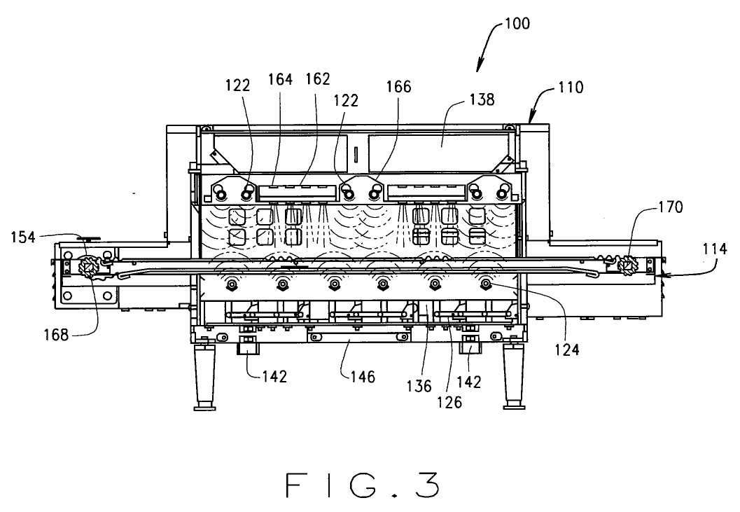

Upper and lower infrared heating elements 122 and 124, are located within the cooking chamber 112 above and below the conveyor 114 and adjacent the impingement panels 162 (FIGS. 2-3). Reflectors 166 are mounted above the upper infrared heating elements 122 to reflect infrared energy from the upper elements 122 towards the conveyor 114 (FIG. 3). Therefore, the reflectors 166 increase the efficiency of the upper elements 122 by focusing the resultant infrared energy downwardly towards the conveyor 114. Moreover, infrared energy not reflected towards the conveyor 114 by the reflectors 166 from the upper elements 122 is used to heat the air flow moving from the circulation duct 134 to the impingement panels 162. Preferably, each reflector 166 is an elongated metal tray with a generally U-shaped cross-section. However, other size, shapes, and materials can be used.

Locating infrared heating elements 122 and 124 both above and below the conveyor 114 permits toasting of both the top and bottom of food items 120, as well as resulting in an overall faster cooking time. Although, the infrared heating elements 122 and 124 primarily emit infrared or radiant energy to the food items 120, some energy conducts with the air, thereby, raising the temperature of the air flow for convection cooking. In FIGS. 2-3, the infrared heating elements 122 and 124 are preferably quartz infrared heaters. However, those skilled in the art will recognize that other types of infrared heating elements can be used that emit long medium wavelength or short wavelength infrared energy, such as gas, metal sheathed, ceramic, or gas infrared heaters.

Convection heating elements 126 are disposed within the cooking chamber 112 below the conveyor 114 and the lower infrared heating elements 124 (FIGS. 2-4, and 9). The convection heating elements 126 primarily conduct heat with the air flow for convection cooking of the food items 120. Preferably, the heating elements 126 are only used to maintain the selected air temperature. However, some radiant energy is emitted towards the conveyor 114 for cooking of the food items 120. While the convection heating elements 126 are preferably electric, other types of convection heating elements can be used, such as, gas burners.

The conveyor 114 includes a pair of parallel rollers 168 and 170 mounted to opposite ends of the housing 110 outside the cooking chamber 112 and adjacent to respective entrance and exit openings 116 and 118 (FIG. 2). A continuous, or endless, belt 172 engages with the rollers 168 and 170 to form a loop with an upper conveying portion 174, which conveys food items 120, and a lower return portion 176 below and generally parallel to the conveying portion 174. Any type of continuous or endless belt, which are well known to those skilled in the art, can be used in the present invention. A conveyor motor 154 engages one of rollers 168 and 170, preferably the entrance roller 168, and rotates the roller 168, which in turn advances the belt 172 in a continuous loop about the rollers 168 and 170. The speed of the belt 172 is determined by the speed of the motor 154, which is controlled by the control panel 130.

In operation, food items 120 are placed on the conveyor 114. As the conveyor 114 conveys the food items 120 through the cooking chamber 112, the food items 120 are cooked simultaneous with radiant energy from the infrared heating elements 122 and 124 and convection heat from the circulating heated air circulated. The blower assembly 128 draws air over and around the heating elements 122, 124, and 126 by the force of the fan 156 to heat the air to a desired temperature. Also, the blower assembly 128 forces the air through the impingement panels 162 to impinge the food items 120 with jets of heated air. Having all the heating elements 122, 124, and 126 located within the cooking chamber 112 reduces the thermal inefficiencies of the oven 100, of the cooking chamber 112, and also removes a restriction from the circulation duct 134. In addition, the lives of the blower motor 152, conveyor motor 178, and electrical components 150 are extended due to the reduction in exposure to high temperatures. Preferably, the sensor for air temperature control is located in the cooking chamber 112 above the heating elements 122, 124, and 126 and the reflectors 166. This location allows sensing of air that has passed over the elements 122, 124, and 126 and been mixed in the fan 156. Moreover, there is no direct infrared energy from the heating elements 122, 124, and 126 to affect the accuracy. This arrangement allows the sensor to acquire an accurate temperature of the air within the cooking chamber 112.

Changes can be made in the above constructions without departing from the scope of the invention, it is intended that all matter contained in the above description or shown in the accompanying drawings shall be interpreted as illustrative and not in a limiting sense.

What is claimed is:

1. An oven for heating food items, comprising:
a housing having a cooking chamber, a circulation duct in communication with the cooking chamber, and a controls chamber;
a conveyor for conveying food items through the cooking chamber;
an upper infrared heating element disposed within the cooking chamber and positioned above the conveyor for emitting radiant energy to the food items;
a lower infrared heating element disposed within the cooking chamber and positioned below the conveyor for emitting radiant energy to the food items;
a convective heating element disposed within the cooking chamber; and
a fan assembly engaged with the blower motor and disposed within the circulation duct for circulating heated air through the cooking chamber.

2. The impingement oven of claim 1, further comprising:
a reflector positioned above the upper infrared heating element, the reflector being sized and shaped to reflect infrared energy from the upper elements towards the conveyor.

3. The impingement oven of claim 2, further comprising:
a temperature sensor positioned above the reflector to prevent direct exposure to radiant energy, the temperature sensor being capable of measuring the temperature of the heated air.

4. The impingement oven of claim 1, further comprising:
a blower motor disposed within the controls chamber
an inlet to the housing, the inlet being sized to receive ambient air;
a cooling channel in communication with the inlet and the controls chamber; and
wherein the fan assembly is capable of drawing ambient air into the inlet through the cooling channel to the control chamber.

5. The impingement oven of claim 4, further comprising:
an upper cooling channel in communication with the inlet and the controls chamber.

6. The impingement oven of claim 1, further comprising:
a blower motor disposed within the controls chamber an inlet to the housing, the inlet being sized to receive ambient air;
a cooling channel in communication with the inlet and a front control area; and
wherein the fan assembly is capable of drawing ambient air into the inlet through the cooling channel to the front control area.

7. The impingement oven of claim 1, further comprising a control panel disposed in the controls chamber.

8. The impingement oven of claim 1, wherein the blower motor is positioned to avoid direct exposure of radiant energy from the infrared heating element.

9. The impingement oven of claim 1, further comprising:
an impingement panel positioned above the conveyor and defining a plurality of apertures sized and shaped to direct heated air towards the conveyor at increased speeds for impingement of the food items.

10. An impingement oven for heating food items, comprising:
a housing having a cooking chamber, a circulation duct in communication with the cooking chamber, and a controls chamber;
a conveyor for conveying food through the cooking chamber;
an impingement panel positioned above the conveyor and defining a plurality of apertures sized and shaped to direct heated air towards the conveyor at increased speeds for impingement of the food items;
infrared heating elements disposed within the cooking chamber and positioned above and below the conveyor for emitting radiant energy to the food items;
convective heating elements disposed within the cooking chamber; and
a fan assembly engaged with the blower motor and disposed within the circulation duct for circulating heated air through the cooking chamber.

11. The impingement oven of claim 10, further comprising:
a reflector positioned above the upper infrared heating element, the reflector being sized and shaped to reflect infrared energy from the upper elements towards the conveyor.

12. The impingement oven of claim 11, further comprising:
a temperature sensor positioned above the reflector to prevent direct exposure to radiant energy, the temperature sensor being capable of measuring the temperature of the heated air.

13. The impingement oven of claim 10, further comprising:
a blower motor disposed within the controls chamber
an inlet to the housing, the inlet being sized to receive ambient air;
a cooling channel in communication with the inlet and the controls chamber; and
wherein the fan assembly is capable of drawing ambient air into the inlet through the cooling channel to the control chamber.

14. The impingement oven of claim 13, further comprising:
an upper cooling channel in communication with the inlet and the controls chamber.

15. The impingement oven of claim 10, further comprising:
a blower motor disposed within the controls chamber
an inlet to the housing, the inlet being sized to receive ambient air;
a cooling channel in communication with the inlet and a front control area; and
wherein the fan assembly is capable of drawing ambient air into the inlet through the cooling channel to the front control area.

16. The impingement oven of claim 10, further comprising a control panel disposed in the controls chamber.

17. The impingement oven of claim 10, wherein the blower motor is positioned to avoid direct exposure of radiant energy from the infrared heating element.

18. The impingement oven of claim 10, further comprising:
an impingement panel positioned above the conveyor and defining a plurality of apertures sized and shaped to direct heated air towards the conveyor at increased speeds for impingement of the food items.

19. An impingement oven for heating food items, comprising:
a housing having a cooking chamber, a circulation duct in communication with the cooking chamber, and a controls chamber;
a conveyor for conveying food through the housing;
a infrared heating means disposed within the cooking chamber and positioned above and below the conveyor for emitting radiant energy to the food items;
a convective heating means disposed within the cooking chamber; and
a means for circulating heated air through the cooking chamber.

20. The impingement oven of claim 10, the means for circulating comprising:
a blower motor disposed within the controls chamber; and
a fan assembly engaged with the blower motor and disposed within the circulation duct for circulating heated air through the cooking chamber.
